(19) United States
(12) Patent Application Publication
(10) Pub. No.: US 2013/0346683 A1
(43) Pub. Date: Dec. 26, 2013

(54) Cache Sector Dirty Bits

(71) Applicant: William L. Walker, Fort Collins, CO (US)

(72) Inventor: William L. Walker, Fort Collins, CO (US)

(21) Appl. No.: 13/530,907

(22) Filed: Jun. 22, 2012

(51) Int. Cl. G06F 12/08

(52) U.S. Cl. 711/105; 711/122; 711/118; 711/128; 711/E12.018; 711/E12.024

(57) ABSTRACT

A cache subsystem apparatus and method of operating therefor is disclosed. In one embodiment, a cache subsystem includes a cache memory divided into a plurality of sectors each having a corresponding plurality of cache lines. Each of the plurality of sectors is associated with a sector dirty bit that, when set, indicates at least one of its corresponding plurality of cache lines is storing modified data of any other location in a memory hierarchy including the cache memory. The cache subsystem further includes a cache controller configured to, responsive to initiation of a power down procedure, determine only in sectors having a corresponding sector dirty bit set which of the corresponding plurality of cache lines is storing modified data.

### BACKGROUND

1. Technical Field

This disclosure relates to processors, and more particularly, to cache subsystems in processors.

2. Description of the Related Art

As integrated circuit technology has advanced, the feature size of transistors has continued to shrink. This has enabled more circuitry to be implemented on a single integrated circuit die. This in turn has allowed for the implementation of more functionality on integrated circuits. Processors having multiple cores are one example of the increased amount of functionality that can be implemented on an integrated circuit.

During the operation of processors having multiple cores, there may be instances when at least one of the cores is inactive. In such instances, an inactive processor core may be powered down in order to reduce overall power consumption. Powering down an idle processor core may include powering down various subsystems implemented therein, including a cache. In some cases, various cache lines within the cache may be ‘dirty’, i.e. may be storing modified data that is exclusive to that cache or modified data which is otherwise under ownership of that cache. Prior to a power down of the processor core (or the cache subsystem implemented therein), each line of the cache may be checked to see if it is dirty. The data included in cache lines indicated as dirty may be written to a lower level cache (e.g. from a level 1, or L1 cache, to a level 2, or L2 cache), or written back to memory. After all data from dirty lines have been written to a lower level cache or back to memory, the cache subsystem may be ready for powering down.

### SUMMARY OF EMBODIMENTS OF THE DISCLOSURE

A cache subsystem apparatus and method of operating therefor is disclosed. In one embodiment, a cache subsystem includes a cache memory divided into a plurality of sectors each having a corresponding plurality of cache lines. Each of the plurality of sectors is associated with a sector dirty bit that, when set, indicates at least one of its corresponding plurality of cache lines is storing modified data. The cache subsystem further includes a cache controller configured to, responsive to initiation of a power down procedure, determine only in sectors having a corresponding sector dirty bit set which of the corresponding plurality of cache lines is storing modified data.

In one embodiment, a method includes searching a cache memory for modified data stored therein. The searching of the cache memory may be performed responsive to initiating a power-down sequence. The cache memory is divided into a plurality of sectors each having a corresponding plurality of cache lines and being associated with a corresponding sector dirty bit that, when set, indicates at least one of its corresponding plurality of cache lines is storing modified data. The searching comprises searching for modified data only in sectors having a corresponding sector dirty bit set.

### BRIEF DESCRIPTION OF THE DRAWINGS

Other aspects of the disclosure will become apparent upon reading the following detailed description and upon reference to the accompanying drawings which are now described as follows.

FIG. 1 is a block diagram of one embodiment of a computer system.

FIG. 2 is a block diagram of one embodiment of a processor having multiple cores and at least one shared cache.

FIG. 3 is a block diagram of one embodiment of a cache subsystem.

FIG. 4 is a block diagram of one embodiment of a cache divided into sectors each of which is associated with a sector dirty bit.

FIG. 5 is a diagram illustrating one embodiment of a sector of a cache;

FIG. 6 is a block diagram illustrating one embodiment of a cache implemented using a plurality of banks with the sectors distributed across the plurality of banks

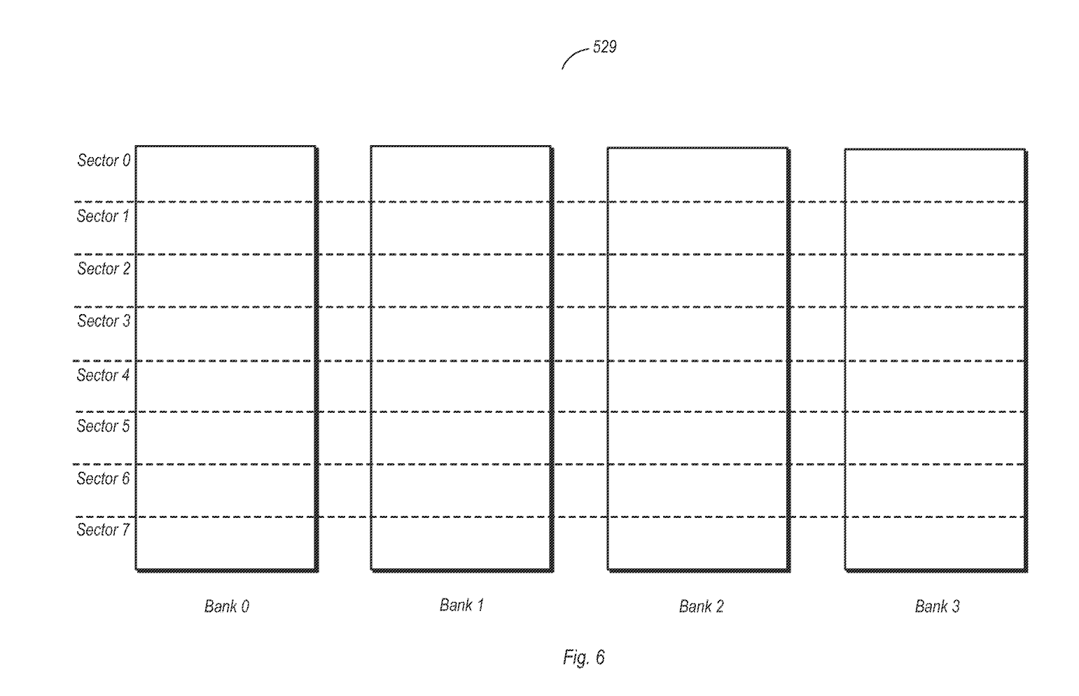

FIG. 7 is a flow diagram illustrating one embodiment of a method for flushing a cache prior to a power-down procedure.

FIG. 8 is a block diagram illustrating one embodiment of a computer readable medium including a data structure describing an embodiment of a cache subsystem.

While the invention is susceptible to various modifications and alternative forms, specific embodiments thereof are shown by way of example in the drawings and will herein be described in detail. It should be understood, however, that the drawings and description thereto are not intended to limit the invention to the particular form disclosed, but, on the contrary, the invention is to cover all modifications, equivalents, and alternatives falling within the spirit and scope of the present invention as defined by the appended claims.

### DETAILED DESCRIPTION

The present disclosure is directed to the operation of a cache subsystem including a cache that is divided into a number of sectors. In one embodiment, each way of the cache may include a number of sectors. Each sector may include a number cache lines. Each sector may be associated with a sector dirty bit that indicates that at least one of its cache lines is storing modified data. As defined herein, the term “modified data” refers to data that has been modified and is either under ownership of the cache or otherwise stored exclusively in a cache line of only a single cache but nowhere else in the memory hierarchy. Cache lines storing modified data as defined herein are commonly referred to as “dirty”, and thus any reference to a dirty cache line in this disclosure is directed to a cache line storing modified data that is not stored anywhere else in the memory hierarchy.

In one embodiment, a cache subsystem may operate under the MOESI (Modified, Owned, Exclusive, Shared, Invalid) protocol, which is an extension of the MESI (Modified, Exclusive, Shared, Invalid) protocol. In the MOESI protocol, a cache may store modified data therein and may have ownership of the modified data, but may also share that data with other caches within a memory hierarchy or within other memory hierarchies (e.g., caches in other processor cores of a multi-core processor). The modified data that is owned may be the most recent, correct copy of the data. When a cache has ownership of modified data, responsibility for writing that data back to memory in the event of a cache flush. A cache having ownership of data in a cache line may also respond to snoop requests originated elsewhere in the processor. Thus, referring again to the definition given above, the term ‘modified data’ as used in this disclosure may refer to data in a cache line that is either owned by that cache or is stored exclusively in that cache.

In one embodiment, responsive to receiving an indication that the cache subsystem (or functional unit in which it is implemented, e.g., a processor core) is to be powered down, a cache controller may search the cache for dirty cache lines. In conducting the search, the cache controller may search cache lines only in those sectors for which the corresponding sector dirty bit is set. Cache lines in sectors in which the sector dirty bit is not set are not searched for dirty cache lines, which may result in the search being of a shorter duration. Cache lines having modified data stored therein may be marked as dirty by a corresponding cache line dirty bit. Modified data stored in instances of cache lines that are marked dirty by their respective dirty bits may be written to another storage location in the memory hierarchy. In one embodiment, the modified data may be written to a lower level cache, while in another embodiment the modified data may be written back to main memory. Another embodiment is contemplated in which the modified data is written to both of a lower level cache and main memory.

After each found instance of modified data stored in the cache has been written to another storage location, the cache may be considered to be flushed, or clean of modified data. Responsive thereto, the cache controller may assert a signal indicating that the cache is flushed and thus the cache subsystem is ready for being powered down. By limiting the search for dirty cache lines to only sectors in which the corresponding sector dirty bit is set, the cache flush operation may be completed in a shorter time period, and thereby allow for faster powering down of the cache subsystem and/or a functional unit in which it is implemented. This in turn may achieve greater power savings, as the cache subsystem/functional unit may spend more time powered down when it has no scheduled processing tasks.

In one embodiment, one or more instances of the cache subsystem may be implemented in each of a number of processors cores in a multi-core processor. The multi-core processor may include a power management unit configured to monitor activity of the processor cores. Responsive to detecting an idle processor core, the power management unit may initiate a power down procedure for the idle core. The power down procedure may include flushing each cache capable of storing modified data, as described above. When all caches are flushed, the cache subsystems in the processor core may for powering down. If other portions of the processor core are also ready for powering down, the power management unit may remove power therefrom. Power may be restored to the core should it become active again. In some cases, the time that a processor core is active after being powered on again may be short. For example a processor core may be woken from a sleep state (i.e. powered on after being powered down) to handle an interrupt. After the handling of the interrupt is complete, the processor core may become idle again, and may thus be powered down. By focusing the search for dirty cache lines to only those sectors having a corresponding sector dirty bit set, cache flush operations may be completed more quickly than in embodiments where the entire cache is searched. This may in turn allow for a faster shutdown of the processor core.

Furthermore, when a processor core is awakened for short-lived periods, the writing of modified data to a cache may be relatively localized, and in some cases limited to only a single sector. In such instances, only a small portion of the cache is searched for dirty cache lines for a subsequent cache flush, which may be completed in a significantly reduced amount of time relative to that required for searching the entirety of the cache. Various method embodiments of performing faster cache flushes and exemplary apparatus embodiments capable of the same are discussed in further detail below.

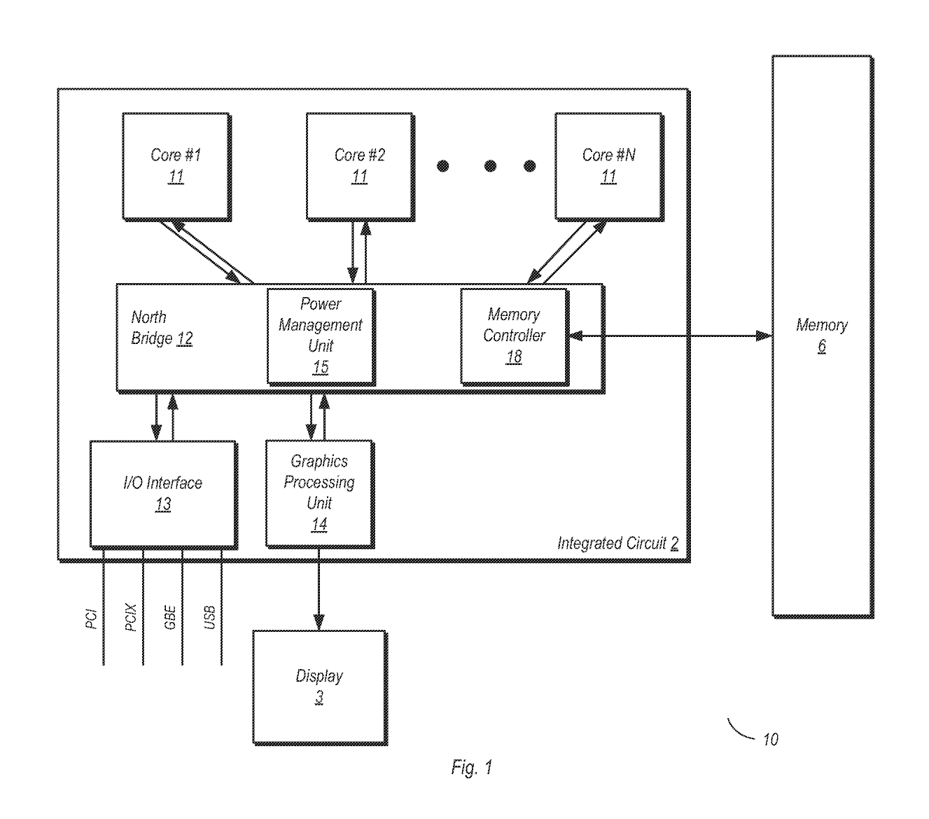

FIG. 1 is a block diagram of one embodiment of a computer system 10. In the embodiment shown, computer system 10 includes integrated circuit (IC) 2 coupled to a memory 6. In the embodiment shown, IC 2 is a system on a chip (SoC) having a number of processor cores 11, which are processor cores in this embodiment. In various embodiments, the number of processor cores may be as few as one, or may be as many as feasible for implementation on an IC die. In multi-core embodiments, processor cores 11 may be identical to each other (i.e. symmetrical multi-core), or one or more cores may be different from others (i.e. asymmetric multi-core). Processor cores 11 may each include one or more execution units, cache memories, schedulers, branch prediction circuits, and so forth. Furthermore, each of processor cores 11 may be configured to assert requests for access to memory 6, which may function as the main memory for computer system 10. Such requests may include read requests and/or write requests, and may be initially received from a respective processor core 11 by north bridge 12. Requests for access to memory 6 may be initiated responsive to the execution of certain instructions, and may also be initiated responsive to prefetch operations.

I/O interface 13 is also coupled to north bridge 12 in the embodiment shown. I/O interface 13 may function as a south bridge device in computer system 10. A number of different types of peripheral buses may be coupled to I/O interface 13. In this particular example, the bus types include a peripheral component interconnect (PCI) bus, a PCI-Extended (PCI-X), a PCIE (PCI Express) bus, a gigabit Ethernet (GBE) bus, and a universal serial bus (USB). However, these bus types are exemplary, and many other bus types may also be coupled to I/O interface 13. Various types of peripheral devices (not shown here) may be coupled to some or all of the peripheral buses. Such peripheral devices include (but are not limited to) keyboards, mice, printers, scanners, joysticks or other types of game controllers, media recording devices, external storage devices, network interface cards, and so forth. At least some of the peripheral devices that may be coupled to I/O unit 13 via a corresponding peripheral bus may assert memory access requests using direct memory access (DMA). These requests (which may include read and write requests) may be conveyed to north bridge 12 via I/O interface 13.

In the embodiment shown, IC 2 includes a graphics processing unit 14 that is coupled to display 3 of computer system 10. Display 3 may be a flat-panel LCD (liquid crystal display), plasma display, a CRT (cathode ray tube), or any other suitable display type. GPU 14 may perform various video processing functions and provide the processed information to display 3 for output as visual information.

Memory controller 18 in the embodiment shown is integrated into north bridge 12, although it may be separate from north bridge 12 in other embodiments. Memory controller 18 may receive memory requests conveyed from north bridge 12. Data accessed from memory 6 responsive to a read request (including prefetches) may be conveyed by memory controller 18 to the requesting agent via north bridge 12. Responsive to a write request, memory controller 18 may receive both the request and the data to be written from the requesting agent via north bridge 12. If multiple memory access requests are pending at a given time, memory controller 18 may arbitrate between these requests.

Memory 6 in the embodiment shown may be implemented in one embodiment as a plurality of memory modules. Each of the memory modules may include one or more memory devices (e.g., memory chips) mounted thereon. In another embodiment, memory 6 may include one or more memory devices mounted on a motherboard or other carrier upon which IC 2 may also be mounted. In yet another embodiment, at least a portion of memory 6 may be implemented on the die of IC 2 itself. Embodiments having a combination of the various implementations described above are also possible and contemplated. Memory 6 may be used to implement a random access memory (RAM) for use with IC 2 during operation. The RAM implemented may be static RAM (SRAM) or dynamic RAM (DRAM). Type of DRAM that may be used to implement memory 6 include (but are not limited to) double data rate (DDR) DRAM, DDR2 DRAM, DDR3 DRAM, and so forth.

Although not explicitly shown in FIG. 1, IC 2 may also include one or more cache memories that are external to the processor cores 11. As will be discussed below, each of the processor cores 11 may include an L1 data cache and an L1 instruction cache. In some embodiments, each processor core 11 may be associated with a corresponding L2 cache. Each L2 cache may be internal or external to its corresponding processor core. An L3 cache that is shared among the processor cores 11 may also be included in one embodiment of IC 2. In general, various embodiments of IC 2 may implement a number of different levels of cache memory, with some of the cache memories being shared between the processor cores while other cache memories may be dedicated to a specific one of processor cores 11.

North bridge 12 in the embodiment shown also includes a power management unit 15, which may be used to monitor and control power consumption among the various functional units of IC 2. More particularly, power management unit 15 may monitor activity levels of each of the other functional units of IC 2, and may perform power management actions is a given functional unit is determined to be idle (e.g., no activity for a certain amount of time). In addition, power management unit 15 may also perform power management actions in the case that an idle functional unit needs to be activated to perform a task. Power management actions may include removing power, gating a clock signal, restoring power, restoring the clock signal, reducing or increasing and operating voltage, and reducing and increasing a frequency of a clock signal. In some cases, power management unit 15 may also re-allocate workloads among the processor cores 11 such that each may remain within thermal design power limits. In general, power management unit 15 may perform any function related to the control and distribution of power to the other functional units of IC 2.

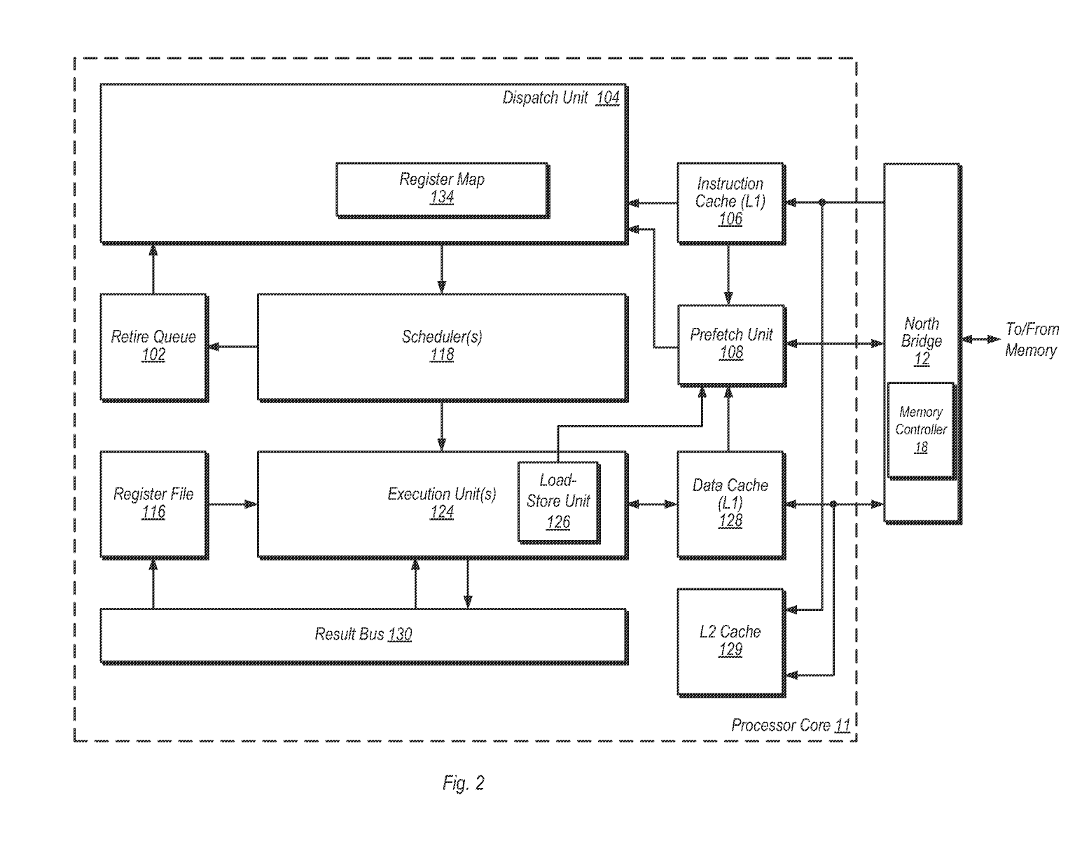

FIG. 2 is a block diagram of one embodiment of a processor core 11. The processor core 11 is configured to execute instructions stored in a system memory (e.g., memory 6 of FIG. 1). Many of these instructions may also operate on data stored in memory 6. It is noted that the memory 6 may be physically distributed throughout a computer system and/or may be accessed by one or more processing nodes 11.

In the illustrated embodiment, the processor core 11 may include an L1 instruction cache 106 and an L1 data cache 128. The processor core 11 may include a prefetch unit 108 coupled to the instruction cache 106, which will be discussed in additional detail below. A dispatch unit 104 may be configured to receive instructions from the instruction cache 106 and to dispatch operations to the scheduler(s) 118. One or more of the schedulers 118 may be coupled to receive dispatched operations from the dispatch unit 104 and to issue operations to the one or more execution unit(s) 124. The execution unit(s) 124 may include one or more integer units, one or more floating point units. At least one load-store unit 126 is also included among the execution units 124 in the embodiment shown. Results generated by the execution unit(s) 124 may be output to one or more result buses 130 (a single result bus is shown here for clarity, although multiple result buses are possible and contemplated). These results may be used as operand values for subsequently issued instructions and/or stored to the register file 116. A retire queue 102 may be coupled to the scheduler(s) 118 and the dispatch unit 104. The retire queue 102 may be configured to determine when each issued operation may be retired.

In one embodiment, the processor core 11 may be designed to be compatible with the x86 architecture (also known as the Intel Architecture-32, or IA-32). In another embodiment, the processor core 11 may be compatible with a 64-bit architecture. Embodiments of processor core 11 compatible with other architectures are contemplated as well.

Note that the processor core 11 may also include many other components. For example, the processor core 11 may include a branch prediction unit (not shown) configured to predict branches in executing instruction threads. In some embodiments (e.g., if implemented as a stand-alone processor), processor core 11 may also include a memory controller configured to control reads and writes with respect to memory 6.

The instruction cache 106 may store instructions for fetch by the dispatch unit 104. Instruction code may be provided to the instruction cache 106 for storage by prefetching code from the system memory 200 through the prefetch unit 108. Instruction cache 106 may be implemented in various configurations (e.g., set-associative, fully-associative, or direct-mapped).

Processor core 11 may also be associated with an L2 cache 129. In the embodiment shown, L2 cache 129 is internal to and included in the same power domain as processor core 11. Embodiments wherein L2 cache 129 is external to and separate from the power domain as processor core 11 are also possible and contemplated. Whereas instruction cache 106 may be used to store instructions and data cache 128 may be used to store data (e.g., operands), L2 cache 129 may be a unified cache used to store instructions and data. However, embodiments are also possible and contemplated wherein separate L2 caches are implemented for instructions and data.

The dispatch unit 104 may output operations executable by the execution unit(s) 124 as well as operand address information, immediate data and/or displacement data. In some embodiments, the dispatch unit 104 may include decoding circuitry (not shown) for decoding certain instructions into operations executable within the execution unit(s) 124. Simple instructions may correspond to a single operation. In some embodiments, more complex instructions may correspond to multiple operations. Upon decode of an operation that involves the update of a register, a register location within register file 116 may be reserved to store speculative register states (in an alternative embodiment, a reorder buffer may be used to store one or more speculative register states for each register and the register file 116 may store a committed register state for each register). A register map 134 may translate logical register names of source and destination operands to physical register numbers in order to facilitate register renaming. The register map 134 may track which registers within the register file 116 are currently allocated and unallocated.

The processor core 11 of FIG. 2 may support out-of-order execution. The retire queue 102 may keep track of the original program sequence for register read and write operations, allow for speculative instruction execution and branch misprediction recovery, and facilitate precise exceptions. In some embodiments, the retire queue 102 may also support register renaming by providing data value storage for speculative register states (e.g. similar to a reorder buffer). In other embodiments, the retire queue 102 may function similarly to a reorder buffer but may not provide any data value storage. As operations are retired, the retire queue 102 may deallocate registers in the register file 116 that are no longer needed to store speculative register states and provide signals to the register map 134 indicating which registers are currently free. By maintaining speculative register states within the register file 116 (or, in alternative embodiments, within a reorder buffer) until the operations that generated those states are validated, the results of speculatively-executed operations along a mispredicted path may be invalidated in the register file 116 if a branch prediction is incorrect.

In one embodiment, a given register of register file 116 may be configured to store a data result of an executed instruction and may also store one or more flag bits that may be updated by the executed instruction. Flag bits may convey various types of information that may be important in executing subsequent instructions (e.g. indicating a carry or overflow situation exists as a result of an addition or multiplication operation. Architecturally, a flags register may be defined that stores the flags. Thus, a write to the given register may update both a logical register and the flags register. It should be noted that not all instructions may update the one or more flags.

The register map 134 may assign a physical register to a particular logical register (e.g. architected register or microarchitecturally specified registers) specified as a destination operand for an operation. The dispatch unit 104 may determine that the register file 116 has a previously allocated physical register assigned to a logical register specified as a source operand in a given operation. The register map 134 may provide a tag for the physical register most recently assigned to that logical register. This tag may be used to access the operand's data value in the register file 116 or to receive the data value via result forwarding on the result bus 130. If the operand corresponds to a memory location, the operand value may be provided on the result bus (for result forwarding and/or storage in the register file 116) through load-store unit 126. Operand data values may be provided to the execution unit(s) 124 when the operation is issued by one of the scheduler(s) 118. Note that in alternative embodiments, operand values may be provided to a corresponding scheduler 118 when an operation is dispatched (instead of being provided to a corresponding execution unit 124 when the operation is issued).

As used herein, a scheduler is a device that detects when operations are ready for execution and issues ready operations to one or more execution units. For example, a reservation station may be one type of scheduler. Independent reservation stations per execution unit may be provided, or a central reservation station from which operations are issued may be provided. In other embodiments, a central scheduler which retains the operations until retirement may be used. Each scheduler 118 may be capable of holding operation information (e.g., the operation as well as operand values, operand tags, and/or immediate data) for several pending operations awaiting issue to an execution unit 124. In some embodiments, each scheduler 118 may not provide operand value storage. Instead, each scheduler may monitor issued operations and results available in the register file 116 in order to determine when operand values will be available to be read by the execution unit(s) 124 (from the register file 116 or the result bus 130).

The prefetch unit 108 may prefetch instruction code from the memory 6 for storage within the instruction cache 106. In the embodiment shown, prefetch unit 108 is a hybrid prefetch unit that may employ two or more different ones of a variety of specific code prefetching techniques and algorithms. The prefetching algorithms implemented by prefetch unit 108 may be used to generate address from which data may be prefetched and loaded into registers and/or a cache. Prefetch unit 108 may be configured to perform arbitration in order to select which of the generated addresses is to be used for performing a given instance of the prefetching operation.

As noted above, processor core 11 includes L1 data and instruction caches and is associated with at least one L2 cache. In some cases, separate L2 caches may be provided for data and instructions, respectively. The L1 data and instruction caches may be part of a memory hierarchy, and may be below the architected registers of processor core 11 in that hierarchy. The L2 cache(s) may be below the L1 data and instruction caches in the memory hierarchy (and thus be considered as lower level caches as the term is used herein). Although not explicitly shown, an L3 cache may also be present (and may be shared among multiple processor cores 11), with the L3 cache being below any and all L2 caches in the memory hierarchy. Below the various levels of cache memory in the memory hierarchy may be main memory, with disk storage (or flash storage) being below the main memory.

The various caches shown in FIG. 2 may each be implemented as a part of a cache subsystem that includes a cache controller (embodiments of which are discussed below). In the event the processor core 11 is to be powered down, L1 data cache 128 may be flushed by writing modified data stored therein to a lower level storage location in the memory hierarchy (outside of processor core 11). Similarly, L2 cache 129 may also be flushed, since it is capable of storing modified data. A power down procedure may be initiated by power management unit 15 shown in FIG. 1. In one embodiment, power management unit 15 may assert a signal that is provided to processor core 11 and various ones of the functional units implemented therein to initiate the power down procedure. The functional units receiving the signal may include cache controllers associated with cache memories capable of storing modified data (e.g., L1 data cache 128 and L2 cache 129). Responsive to receiving the signal generated by power management unit 15, the corresponding cache controllers may flush their respective caches. Flushing a cache may include searching the cache lines of the cache to determine which of them are dirty (as indicated by a cache line dirty bit) and writing the modified data to another location in the memory hierarchy. In the embodiment shown, at least one of L1 data cache 128 and L2 cache 129 may be subdivided into sectors, each of which is associated with a corresponding sector dirty bit that, when set, indicates that one or more of its respective cache lines are dirty. In such a cache, only those cache lines within a sector having its sector dirty bit are searched during the cache flush procedure. Cache lines in a sector in which its respective sector dirty bit is not set are not searched, which may expedite completion of the cache flush procedure. When a cache flush is complete, its corresponding cache controller may assert a signal indicating the same, thus indicating that it is ready to be powered down.

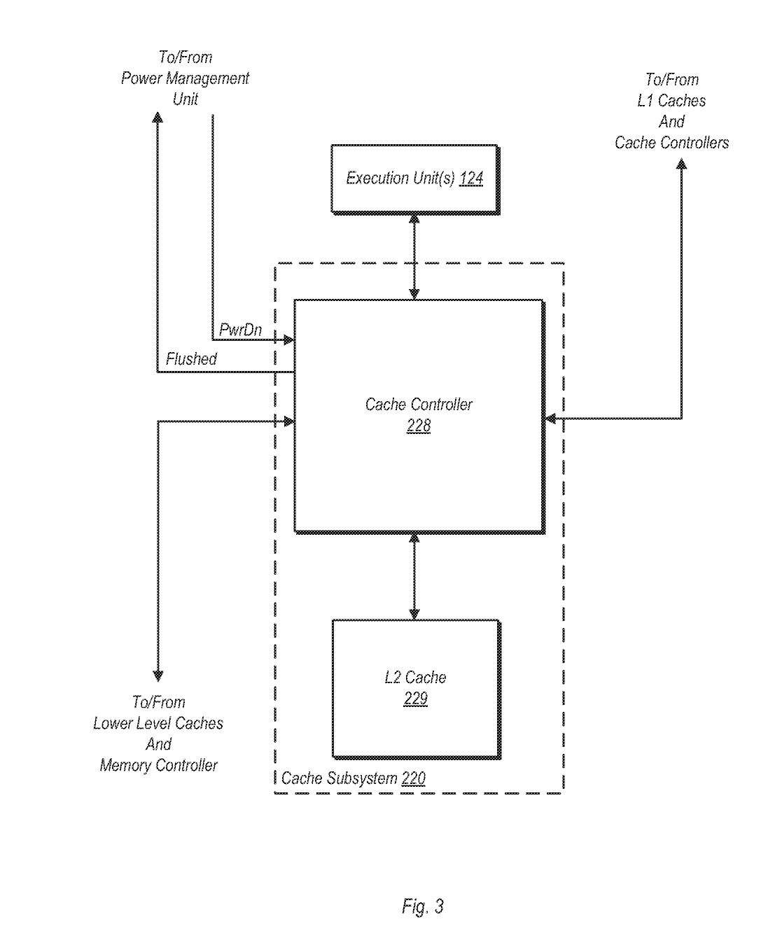

FIG. 3 is a block diagram illustrating one embodiment of an exemplary cache subsystem. In this particular example, cache subsystem is directed to an L2 data cache of a processor core. However, the general arrangement as shown here may apply to any cache subsystem in which modified data may be stored in the corresponding cache.

In the embodiment shown, cache subsystem 220 includes L2 cache 229 and a cache controller 228. L2 cache 229 is a cache that may be used for storing data (e.g., operands, results) and may be implemented in various configurations (e.g., set-associative, fully-associative, or direct-mapped). In one embodiment, L2 cache is an N-way set associative cache, wherein N is an integer value (which may be an integral value of 2).

Cache controller 228 is configured to control access to L2 data cache 229 for both read and write operations. In the particular implementation shown in FIG. 3, cache controller 228 may read and provide data from L2 data cache 229 to execution unit(s) 124 (or to registers to be accessed by the execution units for execution of a particular instruction). In addition, cache controller 228 may also perform evictions of cache lines when the data stored therein is old or is to be removed to add new data. Cache controller 228 may also communicate with other cache subsystems (e.g., to a cache controller for an L1 cache) as well as a memory controller in order to cause data to be written to a location elsewhere in the memory hierarchy. For example, cache controller 228 may convey frequently accessed data to subsystem comprising an L1 data cache. In another example, cache controller 228 may evict seldom (or never) used data to by conveying it to a cache controller associated a lower level (e.g., L3) cache or to main memory (and subsequently erasing or overwriting it in L2 cache 229).

In the embodiment shown, cache controller 228 is coupled to receive a signal (‘PwrDn’) from a power management unit indicating that power is to be removed from the cache subsystem. This may occur, for example, when a processor core in which cache subsystem 220 is implemented is to be put in a sleep state due to idleness. Responsive to receiving this signal, cache controller 228 may flush L2 cache 229. In order to flush L2 cache 229, cache controller 228 may search at least some of the cache lines therein to determine if their corresponding cache line dirty bits are set. Upon determining that a cache line dirty bit is set, cache controller 228 may cause the data stored in the corresponding cache line to be written to a storage location at a lower level in the memory hierarchy (e.g., to an L3 cache, to a main memory, etc.). Once modified data from all dirty cache lines in cache 229 has been written to a lower level storage location, cache controller 228 may assert a signal (‘Flushed’) to indicate that L2 cache 229 has been fully flushed and that it is ready to have its power removed. The indication asserted by cache controller 228 may be provided directly to power management unit 15 in one embodiment. In another embodiment, the indication may be provided to another functional unit within processor core 11, which may subsequently indicate to power management unit 15 when it is in a state suitable for removing power.

In the embodiment shown, L2 cache 229 may be divided into a number of sectors. Each of the sectors may include a number of cache lines. Each sector may be associated with a corresponding sector dirty bit. When modified data is written into and stored in a cache line within a given sector, a corresponding cache line dirty bit may be set. When any cache line dirty bit is set for a cache line within a given sector, the corresponding sector dirty bit may be also be set. A sector dirty bit may, when set, indicate the presence of dirty cache lines within that sector. A sector dirty bit may be in a reset condition when none of its corresponding cache lines have their respective dirty bits set.

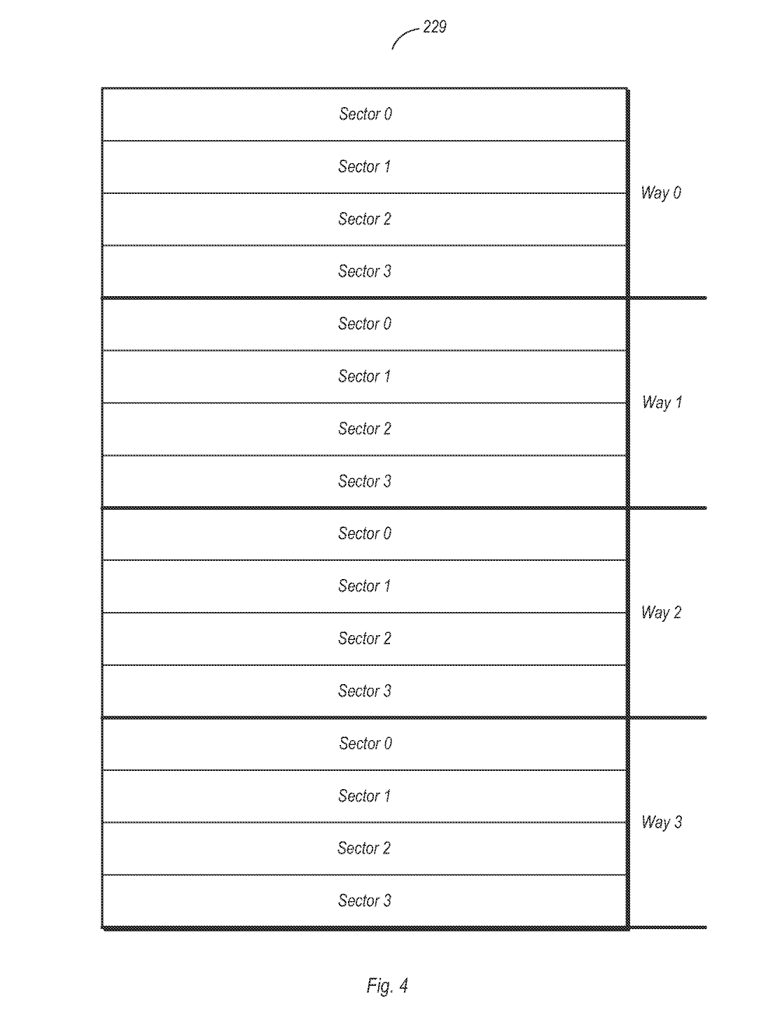

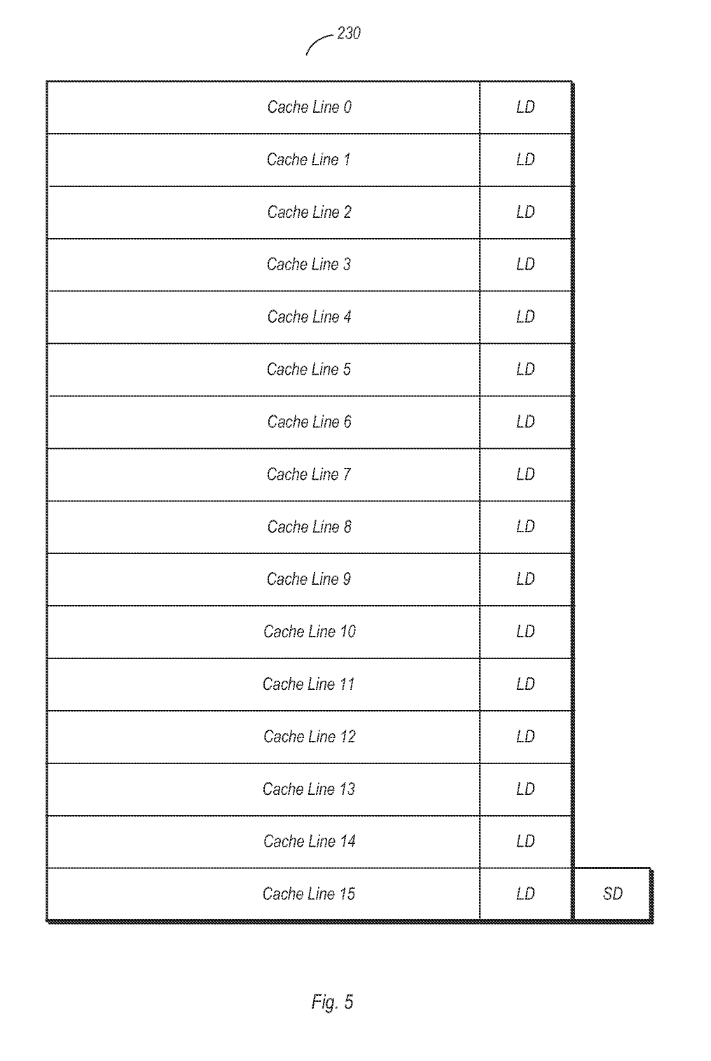

FIGS. 4 and 5 illustrate one embodiment of L2 cache 229 in further detail. It is noted that other caches (e.g., and L1 cache, and L3 cache) may be organized in a manner similar to that of L2 cache 229.

In the embodiment shown, L2 cache 229 is a four-way set-associative cache. Each of the ways in this embodiment includes four sectors. The arrangement for of a given sector for one embodiment is shown in FIG. 5. Sector 230 in the embodiment shown includes sixteen cache lines. Each of the cache lines is associated with a corresponding cache line dirty bit (ID') that may be set when that cache line is dirty. Furthermore, sector 230 also includes a corresponding sector dirty bit that, when set, indicates that at least one of the cache lines therein is dirty. If none of the cache lines in sector 230 is dirty, then each of the cache line dirty bits as well as the sector dirty bit may be in a reset condition. During cache flushes, sector 230 may be searched for dirty cache lines when its corresponding sector dirty bit is set. If its corresponding sector dirty bit is reset, the cache flush operation may be performed without searching sector 230 for dirty cache lines.

It is noted that the number of ways and the number of sectors per way may be different in other embodiments. Furthermore, the division of a cache into sectors is also contemplated for other types of caches that are not set-associative, e.g., a fully associative cache. Furthermore, the number of cache lines per sector may be different than that shown in this particular embodiment. In general, a cache according to this disclosure may be implemented with any suitable number of ways (or no ways), any suitable number of sectors and/or sectors per way, and any suitable number of cache lines per sector.

Turning now to FIG. 5, another embodiment of a cache is shown. Cache 529 in the embodiment shown is implemented using four different banks, banks 0-3. The number of banks may vary from one embodiment to the next. Furthermore, cache 529 in this embodiment includes eight sectors, sectors 0-7. Each of the sectors is distributed across the four banks of this embodiment. Although not explicitly shown, each of the sectors may be associated with a corresponding sector dirty bit as discussed above. The arrangement of cache 529 in this embodiment may allow for even faster searching of sectors for dirty cache lines. In particular, a cache controller associated with cache 529 may concurrently search for dirty cache lines in different banks of the same sector. For example, if sector 0 is indicated as having dirty cache lines therein by its sector dirty bit, a corresponding cache controller may concurrently search for dirty cache lines in each of banks 0, 1, 2, and 3 of sector 0. Thus, the time spent searching for dirty cache lines arranged in a manner similar to cache 529 may be less than that spent flushing a cache in which all lines are searched or when all lines of a given sector are implemented in a single bank of cache memory.

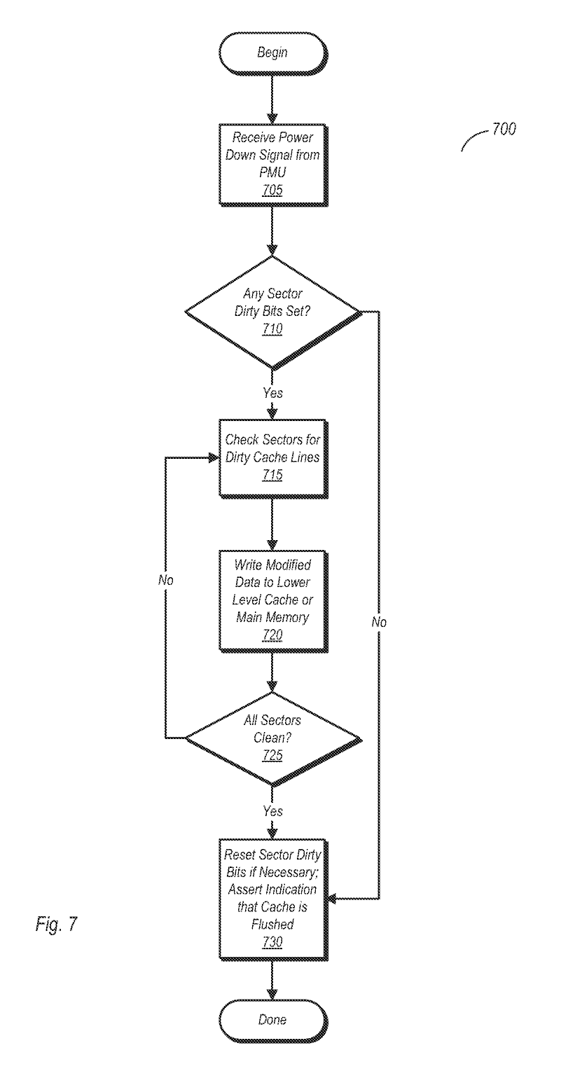

FIG. 7 is a flow diagram illustrating one embodiment of a method for flushing a cache prior to a power-down procedure. Method 700 as discussed herein may be performed in any of the various apparatus embodiments discussed above. Furthermore, it is also possible method 700 may also be performed by apparatus embodiments not explicitly discussed herein.

Method 700 in the embodiment shown begins with a cache controller receiving a power down indication originating from a power management unit (block 705). Responsive to receiving the power down indication, the cache controller may begin a cache flush operation. The cache flush operation may begin with the cache controller checking the sector dirty bits for each of a number of sectors in the cache. If any of the sector bits are set (block 710, yes), then those sectors may be checked for dirty cache lines (block 715). For those sector dirty bits that are not set (i.e. are in the reset state), the corresponding sectors are not searched, as the reset sector dirty bits indicates that they do not contain any dirty cache lines therein.

The sectors marked as dirty by their respective dirty bits may be checked by inspecting the cache line dirty bits of each cache line therein. A cache line dirty bit, when set, indicates the presence of modified data being stored in that cache line. Responsive to determining that the dirty bit for an individual cache line is set, the data stored therein may be written to another storage location that is lower in the memory hierarchy (block 720). The lower level storage location may be in, e.g., a lower level cache or main memory.

If there are still sectors that are not fully clean (block 725, no), then the cache controller may continue its search for dirty cache lines. Otherwise, if all sectors are fully clean (block 725, yes), any previously set sector dirty bits may be reset and the cache controller may assert an indication that the cache is fully clean. The cache may be considered clean when all found instances of modified data have been written to at least one storage location elsewhere in the memory hierarchy. The indication that the cache is fully clean may signal that the cache subsystem is ready for powering down.

If at the beginning of the cache flush procedure it is discovered that all sector dirty bits are in the reset state (block 710, no), indicating that there are no dirty cache lines, then no searching is performed. The cache controller may indicate that the cache is clean (block 730).

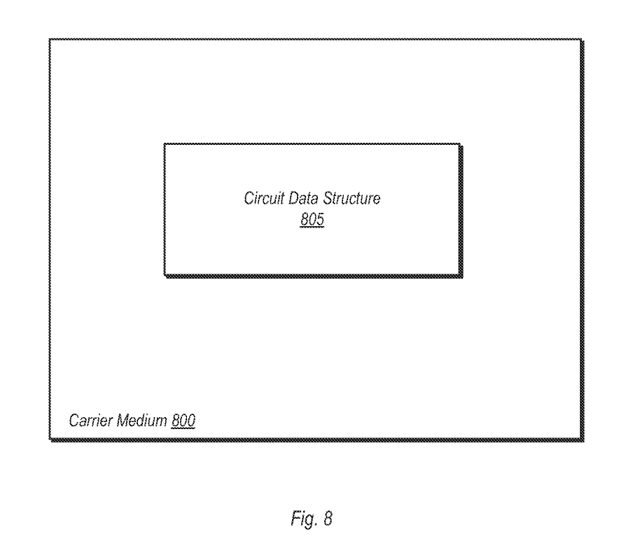

Turning next to FIG. 8, a block diagram of a computer accessible storage medium 800 including a database 805 representative of the system 10 is shown. Generally speaking, a computer accessible storage medium 800 may include any non-transitory storage media accessible by a computer during use to provide instructions and/or data to the computer. For example, a computer accessible storage medium 800 may include storage media such as magnetic or optical media, e.g., disk (fixed or removable), tape, CD-ROM, or DVD-ROM, CD-R, CD-RW, DVD-R, DVD-RW, or Blu-Ray. Storage media may further include volatile or non-volatile memory media such as RAM (e.g. synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g. Flash memory) accessible via a peripheral interface such as the Universal Serial Bus (USB) interface, etc. Storage media may include microelectromechanical systems to (MEMS), as well as storage media accessible via a communication medium such as a network and/or a wireless link.

Generally, the data structure 805 representative of the system 10 and/or portions thereof carried on the computer accessible storage medium 800 may be a database or other data structure which can be read by a program and used, directly or indirectly, to fabricate the hardware comprising the system 10. For example, the data structure 805 may be a behavioral-level description or register-transfer level (RTL) description of the hardware functionality in a high level design language (HDL) such as Verilog or VHDL. The description may be read by a synthesis tool which may synthesize the description to produce a netlist comprising a list of gates from a synthesis library. The netlist comprises a set of gates which also represent the functionality of the hardware comprising the system 10. The netlist may then be placed and routed to produce a data set describing geometric shapes to be applied to masks. The masks may then be used in various semiconductor fabrication steps to produce a semiconductor circuit or circuits corresponding to the system 10. Alternatively, the database 805 on the computer accessible storage medium 800 may be the netlist (with or without the synthesis library) or the data set, as desired, or Graphic Data System (GDS) II data.

While the computer accessible storage medium 800 carries a representation of the system 10, other embodiments may carry a representation of any portion of the system 10, as desired, including IC 2, any set of agents (e.g., processing cores 11, I/O interface 13, north bridge 12, cache subsystems, etc.) or portions of agents. Furthermore, some of the functions carried out by the various hardware/circuits discussed above may also be carried out by the execution of software instructions. Accordingly, some embodiments of data structure 805 may include instructions executable by a processor in a computer system to perform the functions/methods discussed above.

While the present invention has been described with reference to particular embodiments, it will be understood that the embodiments are illustrative and that the invention scope is not so limited. Any variations, modifications, additions, and improvements to the embodiments described are possible. These variations, modifications, additions, and improvements may fall within the scope of the inventions as detailed within the following claims.

What is claimed is:

1. A system comprising:
a cache memory divided into a plurality of sectors each having a plurality of cache lines, and wherein each of the plurality of sectors is associated with a sector dirty bit that, when set, indicates at least one of its corresponding plurality of cache lines is storing modified data; and
a cache controller configured to, responsive to initiation of a power down procedure, determine, only in sectors having a corresponding sector dirty bit set, which of the corresponding plurality of cache lines is storing modified data.

2. The system as recited in claim 1, wherein the cache controller is further configured to cause each found instance of modified data to be written to a location in another memory in a memory hierarchy that includes the cache memory.

3. The system as recited in claim 2, wherein the cache controller is configured to cause each found instance of the modified data to be written to a lower level cache.

4. The system as recited in claim 2, wherein the cache controller is configured to cause each found instance of modified data to be written to a main memory, wherein the main memory is implemented as a dynamic random access memory (DRAM).

5. The system as recited in claim 1, wherein each of the plurality of cache lines is associated with a cache line dirty bit, wherein the cache controller is configured to set the sector dirty bit for a given one of the plurality of sectors responsive to setting a cache line dirty bit for at least one of that sector's corresponding plurality of cache lines.

6. The system as recited in claim 1, wherein the cache memory includes a plurality of ways, and wherein each of the plurality of ways includes a subset of the plurality of sectors.

7. The system as recited in claim 1, wherein the cache memory includes a plurality of banks, wherein each of the sectors is distributed across the plurality of banks

8. The system as recited in claim 5, wherein the cache controller is configured to, responsive to initiation of the power down procedure, concurrently search cache lines in different ones of the plurality of banks but associated with a sector having its corresponding sector dirty bit set.

9. The system as recited in claim 1, wherein the cache controller is configured to reset sector dirty bits responsive to determining that all instances of modified data found in the corresponding one of the plurality of sectors have been written to another memory in a memory hierarchy that includes the cache memory.

10. The system as recited in claim 1, wherein the cache controller is configured to generate a signal indicating that the cache memory is clean responsive to determining that all instances of modified data have been written to another memory in a memory hierarchy that includes the cache memory.

11. A method comprising:
responsive to initiating a power-down sequence, searching a cache memory for modified data, wherein the cache memory is divided into a plurality of sectors each having a plurality of cache lines and being associated with a corresponding sector dirty bit that, when set, indicates at least one of its corresponding plurality of cache lines is storing modified data;
wherein said searching comprises searching for modified data only in sectors having a corresponding sector dirty bit set.

12. The method as recited in claim 11, further comprising writing each found instance of modified data into another memory in a memory hierarchy that includes the cache memory.

13. The method as recited in claim 12, further comprising writing each found instance of modified data into a lower level cache.

14. The method as recited in claim 12, further comprising writing each found instance of modified data into a main memory, wherein the main memory is implemented as dynamic random access memory (DRAM).

15. The method as recited in claim 12, wherein said searching is performed by a cache controller, and wherein the cache controller is further configured to cause said writing.

16. The method as recited in claim 15, further comprising the cache controller generating a signal indicating that the cache memory is clean responsive to determining that all instances of modified data have been conveyed to another memory in the memory hierarchy.

17. The method as recited in claim 11, further comprising setting the sector dirty bit for a given one of the plurality of sectors responsive to setting a cache line dirty bit for one of the plurality of cache lines within the given one of the plurality of sectors.

18. The method as recited in claim 11, further comprising resetting a the sector dirty bit for a given one of the plurality of sectors responsive to determining that all instances of modified data found in the corresponding one of the plurality of sectors have been written to another memory in the memory hierarchy.

19. The method as recited in claim 11, wherein the cache memory includes a plurality of banks, wherein each of the sectors is distributed across the plurality of banks, and wherein the method further comprises concurrently searching cache lines in different ones of the plurality of banks but associated with one of the plurality of sectors having its corresponding sector dirty bit set.

20. The method as recited in claim 11, wherein the cache memory includes a plurality of ways, and wherein each of the plurality of ways includes a subset of the plurality of sectors.

21. An integrated circuit comprising:
a power management unit; and
at least one processor core including a cache subsystem having a cache controller and a cache memory is divided into a plurality of sectors each having a corresponding plurality of cache lines, and wherein each of the plurality of sectors is associated with a sector dirty bit that, when set, indicates at least one of its corresponding plurality of cache lines is storing modified data;
wherein the power management unit is configured to initiate a power down procedure responsive to determining that the at least one processor core is idle;
and wherein the cache controller is configured to, responsive to initiation of the power down procedure, determine only in sectors having a corresponding sector dirty bit set which of the corresponding plurality of cache lines include modified data.

22. The integrated circuit as recited in claim 21, wherein the cache controller is further configured to cause each found instance of modified data to be written to at least one of a lower level cache memory and a main memory.

23. The integrated circuit as recited in claim 21, wherein each of the plurality of cache lines is associated with a cache line dirty bit, wherein the cache controller is configured to set the sector dirty bit for a given one of the plurality of sectors responsive to setting a cache line dirty bit for at least one of that sector's corresponding plurality of cache lines.

24. The integrated circuit as recited in claim 21, wherein the cache memory includes a plurality of banks, wherein each of the sectors is distributed across the plurality of banks, wherein the cache controller is configured to, responsive to initiation of the power down procedure, concurrently search cache lines in different ones of the plurality of banks but associated with a sector having its corresponding sector dirty bit set.

25. The integrated circuit as recited in claim 21, wherein the cache memory includes a plurality of ways, and wherein each of the plurality of ways includes a subset of the plurality of sectors

26. The integrated circuit as recited in claim 21, wherein the cache controller is configured to generate a signal indicating that the cache memory is clean responsive to determining that all instances of modified data have been written to another memory in a memory hierarchy that includes the cache memory.

27. A non-transitory computer readable medium comprising a data structure which is operated upon by a program executable on a computer system, the program operating on the data structure to perform a portion of a process to fabricate an integrated circuit including circuitry described by the data structure, the circuitry described in the data structure including:
a cache memory divided into a plurality of sectors each having a corresponding plurality of cache lines, and wherein each of the plurality of sectors is associated with a sector dirty bit that, when set, indicates at least one of its corresponding plurality of cache lines is storing modified data; and
a cache controller configured to, responsive to initiation of a power down procedure, determine, only in sectors having a corresponding sector dirty bit set, which of the corresponding plurality of cache lines is storing modified data.

28. The computer readable medium as recited in claim 27, wherein the cache controller described by the data structures is further configured to cause each found instance of modified data to be written to at least one of a lower level cache memory and a main memory.

29. The computer readable medium as recited in claim 27, wherein the cache memory described in the data structure includes a plurality of banks, wherein each of the sectors is distributed across the plurality of banks, wherein the cache controller described in the data structure is configured to, responsive to initiation of the power down procedure, concurrently search cache lines in different ones of the plurality of banks but associated with a sector having its corresponding sector dirty bit set.

30. The computer readable medium as recited in claim 27, wherein the data structure comprises one or more of the following types of data:
HDL (high-level design language) data;
RTL (register transfer level) data;
Graphic Data System (GDS) II data.

31. A non-transitory computer readable medium storing instructions which are executable by a processor on a computer system, wherein the instructions, when executed by the processor, perform a method comprising:
responsive to initiating a power-down sequence, searching a cache memory for modified data, wherein the cache memory is divided into a plurality of sectors each having a plurality of cache lines and being associated with a sector dirty bit that, when set, indicates at least one of its corresponding plurality of cache lines is storing modified data;
wherein said searching comprises searching for modified data only in sectors having a respective sector dirty bit set.

32. The computer readable medium as recited in claim 31, wherein the method performed by executing the instructions further comprises writing each found instance of modified data into another memory in the memory hierarchy.

33. The computer readable medium as recited in claim 32, wherein the method performed by executing the instructions further comprises writing each found instance of modified data into a lower level cache.

34. The computer readable medium as recited in claim 32, wherein the method performed by executing the instructions further comprises writing each found instance of modified data into a main memory.
